(19) United States
(12) Patent Application Publication
(10) Pub. No.: US 2015/0029702 A1
(43) Pub. Date: Jan. 29, 2015

(54) Utility Tool

(71) Applicant: Richard Foley, St. Paul, MN (US)

(72) Inventor: Richard Foley, St. Paul, MN (US)

(21) Appl. No.: 14/335,928

(22) Filed: Jul. 20, 2014

Related U.S. Application Data
(60) Provisional application No. 61/857,552, filed on Jul. 23, 2013.

(51) Int. Cl. B26B 1/02; B26B 5/00; B26B 11/00

(52) U.S. Cl. CPC B26B 1/02; B26B 11/008; B26B 5/00
USPC 362/119; 30/321; 30/165

(57) ABSTRACT

The Utility Tool includes a handle, a blade holder, and blade with the blade offset from the handle to facilitate making corner cuts with one edge of the resulting cut being coplanar with one side of the corner.

### CROSS REFERENCE TO RELATED APPLICATIONS

The application listed below is the only application related to this application. This application claims benefit of the earlier filing date under 35 USC 119(e) of provisional application No. 61/857,552 filed on Jul. 23, 2013.

### STATEMENT REGARDING FEDERALLY SPONSORED RESEARCH OR DEVELOPMENT

No invention claimed in this application was made under Federally sponsored research or development.

### THE NAMES OF THE PARTIES TO A JOINT RESEARCH AGREEMENT

Not Applicable

### REFERENCE TO A SEQUENCE LISTING

Not Applicable

### BACKGROUND OF THE INVENTION

1. Field of the Invention

The present invention relates to tools and utility knives and blades for utility knives.

2. Description of Related Art

Various types of utility tools and utility knives are known in the art. There remains a need, however, for a utility tool that allows the user to cut along conjoined surfaces without having to angle the blade of the tool. It is an object of the present invention to provide such a tool.

### BRIEF SUMMARY OF THE INVENTION

The Utility Tool comprises: a handle having a longitudinal axis, and a blade container comprising a blade, the blade defining a blade plane, wherein the blade plane is offset from the longitudinal axis of the handle and the longitudinal axis and blade plane are non-intersecting. The objective of the Utility Tool is to provide a means to make a cut in a corner with at least one side of the cut being as coplanar as possible with one side of the corner.

### BRIEF DESCRIPTION OF THE SEVERAL VIEWS OF THE DRAWING

FIG. 1 is a plan view of the Utility Tool in use.

FIG. 2 is a diagram showing a conventional utility knife in use.

FIG. 2a is a chart showing the approximate angle between a conventional knife and a wall near a corner.

FIG. 3 is a perspective view of the Utility Tool.

FIG. 3a is a side view of a slide assembly for a blade.

FIG. 3b is a an end view of a slide assembly for a blade.

FIG. 4a is a section view of the Utility Tool

FIG. 4a1 is a section view of the a portion of the Utility Tool showing the locking mechanism.

FIG. 4a2 is detail view of the locking mechanism.

FIG. 4b is an illustration of some positions of the blade holder relative to the handle of the Utility Tool.

FIG. 4c is an exploded view of the Utility Tool.

FIG. 4d is a perspective exploded view of the Utility Tool.

FIG. 4e is a perspective exploded view of the locking mechanism of the Utility Tool.

FIG. 5a is a cutaway view showing a blade storage chamber of the Utility Tool.

FIG. 5b is a perspective view of the handle portion of the Utility Tool.

FIG. 5b1 is a section view of the handle showing the blade storage chamber of the Utility Tool.

FIG. 5c is a perspective view of the handle portion showing an alternative storage chamber of blades of the Utility Tool.

FIG. 5c1 is a perspective view of the blade storage slide assembly of the Utility Tool.

FIG. 5d is a cutaway view showing an alternative blade storage chamber of the Utility Tool.

FIG. 5e is a cutaway view showing flashlight assembly.

FIG. 5f is an exploded view showing a flashlight assembly and retraction mechanism of the Utility Tool.

FIG. 6a is a perspective view of the Utility Tool.

FIG. 6b is a perspective view of the Utility Tool showing the cutting head assembly aligned with the handle of the Utility Tool.

FIG. 6c is a top view section view of the Utility Tool showing the assembly for aligning the cutting head assembly with the handle of the Utility Tool.

FIG. 6c1 is a top view of the Utility Tool showing the assembly for aligning the cutting head assembly and the path from offset position to the aligned position.

FIG. 6d is a vertical section view of the Utility Tool showing the assembly for aligning the cutting head assembly with the handle of the Utility Tool.

FIG. 7 is a plan view of an alternative embodiment of the Utility Tool.

FIG. 7b is a rear view of an alternative embodiment of the Utility Tool.

FIG. 8a is a plan view of the double offset reversible blade of the Utility Tool.

FIG. 8a1 is a perspective view of the double offset reversible blade of the Utility Tool showing the offset in a slanted configuration.

FIG. 8b is a plan view of the single offset blade of the Utility Tool.

FIG. 8b1 is a perspective view of single offset blade of the Utility Tool with a non-slanted offset configuration.

FIG. 8c is a plan view of the single offset blade of the Utility Tool.

FIG. 8c1 is a side view of an alternative embodiment of a single offset blade of the Utility Tool.

FIG. 8d is a plan view of an alternative embodiment of a single offset blade of the Utility Tool.

FIG. 8d1 is a side view of an alternative embodiment of a single offset blade of the Utility Tool.

FIG. 8e is a plan view of an alternative embodiment of a single offset blade of the Utility Tool.

FIG. 8e1 is a side view of an alternative embodiment of a single offset blade of the Utility Tool.

FIG. 8f is a plan view of an alternative embodiment of a single offset blade of the Utility Tool.

FIG. 8f1 is a side view of an alternative embodiment of a single offset blade of the Utility Tool.

FIG. 8g is a plan view of an alternative embodiment of a single offset blade, with an angled section, of the Utility Tool.

FIG. 8g1 is a side view of an alternative embodiment of a single offset blade, with an angled section, of the Utility Tool.

FIG. 8h is a plan view of a no offset blade of the Utility Tool.

FIG. 8h1 is a side view of a no offset blade of the Utility Tool.

FIG. 9a is a top view of a left-handed Utility Tool with detachable head assembly.

FIG. 9b is a top view of the Utility Tool with attached handle and right-handed detachable head configuration.

FIG. 9b1 is a cutaway view of handle and right-handed detachable head attached assembly showing locking mechanism.

FIG. 9c is a top view of a right-handed version of the Utility Tool with detachable head assembly.

FIG. 9d is a plan view of a conventional utility knife head assembly with locking mechanism.

FIG. 9d1 is a side view of a conventional utility knife head assembly with locking mechanism.

FIG. 10a is a top view of a blade holder of the Utility Tool showing a blade fastening plate.

FIG. 10a1 is a detailed view of the interlock between the blade fastening plate and the blade holder.

FIG. 10a2 is a detailed view of a second interlock between the blade fastening plate and the blade holder.

FIG. 10b is a side view of the blade fastening plate.

FIG. 10b1 is a detailed view of a second interlock between the blade fastening plate and the blade holder.

FIG. 10c is perspective view of the blade fastening plate.

FIG. 11 is a perspective view of a non retracting blade carrier with blade retaining plate.

FIG. 11a is a perspective view of the double offset reversible blade.

FIG. 11b is a perspective view of blade carrier and blade guard.

FIG. 11c is a perspective view of a blade carrier.

FIG. 11d is a perspective view of a double offset reversible blade in a blade carrier.

FIG. 12 is a perspective view of a blade container.

FIG. 12a is a perspective view of a latching spring.

FIG. 12b is a perspective view of a blade carrier with pushbutton.

FIG. 12b1 is an end view of a blade carrier with pushbutton.

FIG. 12c is a perspective view of a single offset blade.

FIG. 12d is a perspective view of a blade fastening plate

FIG. 13 is an exploded view of the blade holder and latching assembly.

FIG. 13a is a side view of the blade carrier and latch assembly.

FIG. 13a1 is a side view of the blade carrier and latch assembly with single offset blade.

FIG. 13b is a perspective view of a single offset blade.

FIG. 13c is a section view of a single offset blade in a blade carrier with the latch engaged.

FIG. 14 a is a top view of a standard ground cutting edge of a blade for the Utility Tool.

FIG. 14 a is a top view of a right-handed edge ground cutting edge of a blade for the Utility Tool.

FIG. 14 a is a top view of a left-handed edge ground cutting edge of a blade for the Utility Tool.

### DETAILED DESCRIPTION OF THE INVENTION

The Utility Tool comprises: a handle having a longitudinal axis, and a blade container comprising a blade, the blade defining a blade plane, wherein the blade plane is offset from the longitudinal axis of the handle and the longitudinal axis and blade plane are non-intersecting.

Referring to FIG. 2, a PRIOR ART utility knife 5 is shown therein. As will be appreciated, due to the configuration of the PRIOR ART utility knife 5, the minimum angle between the blade and the adjacent surface 3 is approximately 21°.

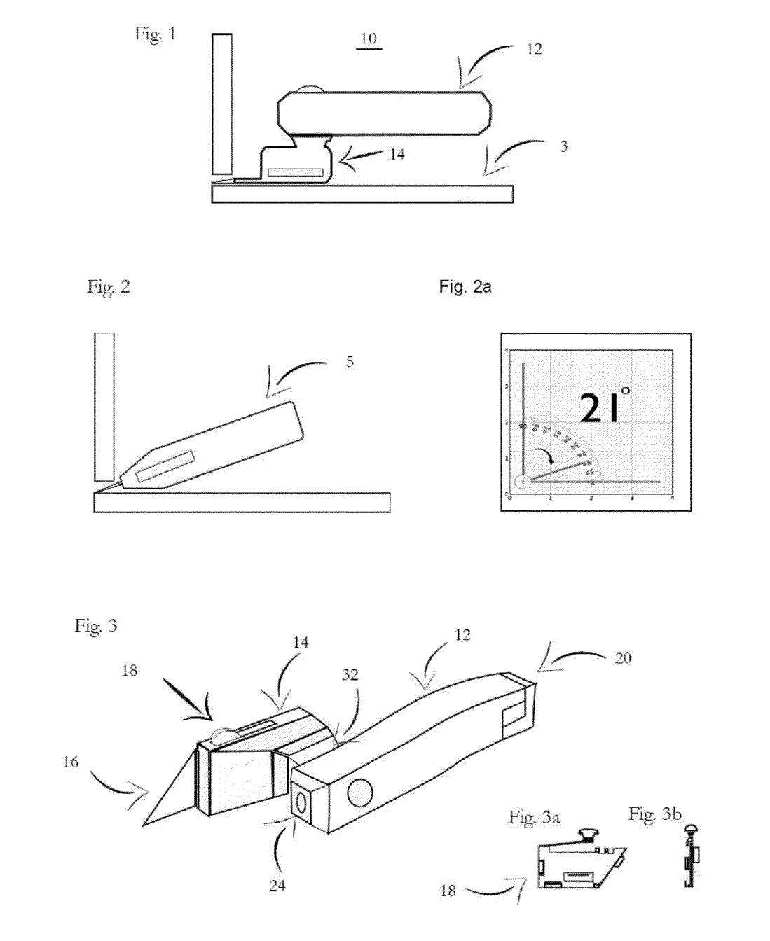

Turning to FIG. 1, however, the minimum angle between the utility Tool 10 and an adjacent surface 3 is as small as 0°, allowing the user to cleanly and accurately cut. By way of example, and as shown in FIG. 1, the Utility Knife 10 can be used to cleanly cut and separate adjoined surfaces along the line of contact.

With further regard to FIG. 1, in some embodiments, the utility Tool has a handle 12 and a blade container 14. Within the blade container 14 resides a blade 16. The blade container 14 is offset from the handle 12, thereby allowing the user to cut in close proximity to an adjacent surface 3.

Turning to FIG. 3, in some embodiments, the blade container 14 has a blade refractor 18 for retracting and deploying the blade 16 from the blade container 14. In some embodiments, the blade retractor 18 is coupled to a movable shuttle plate assembly (not shown), for example as shown in U.S. Pat. Nos. 2,948,961; 4,089,112; 4,663,845; which are herein incorporated by reference, for deployment and retraction of the blade 16.

Further, the handle 12 can include a blade storage cavity 20 for storing extra blades 16. In some embodiments, an end cap 22 slides with respect to the handle 12 to permit access to the blade storage cavity 20.

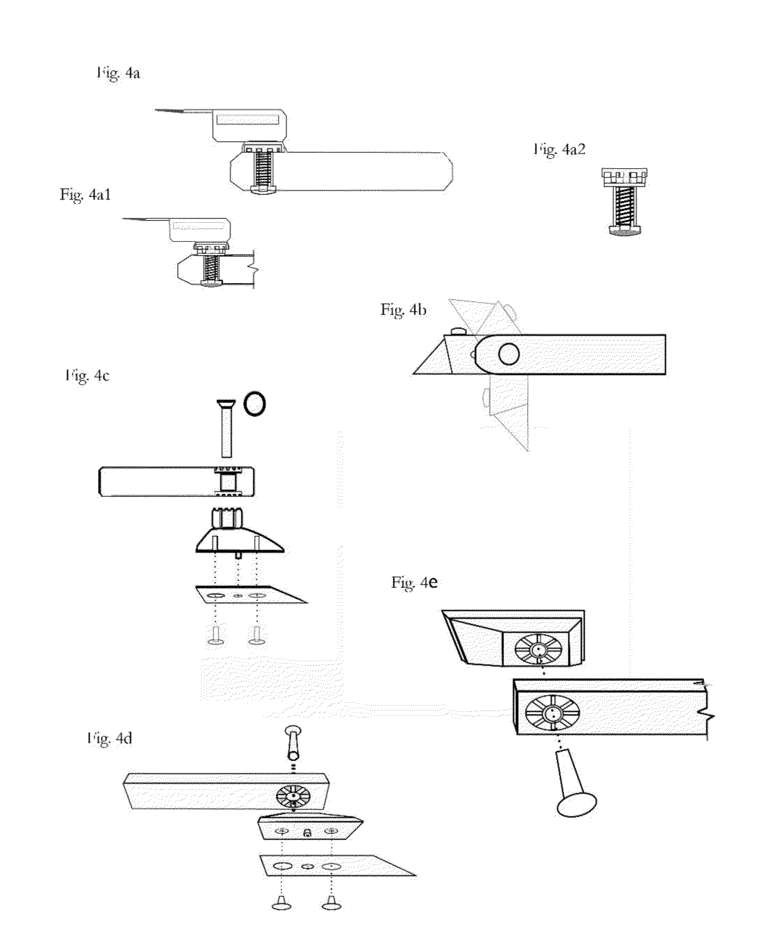

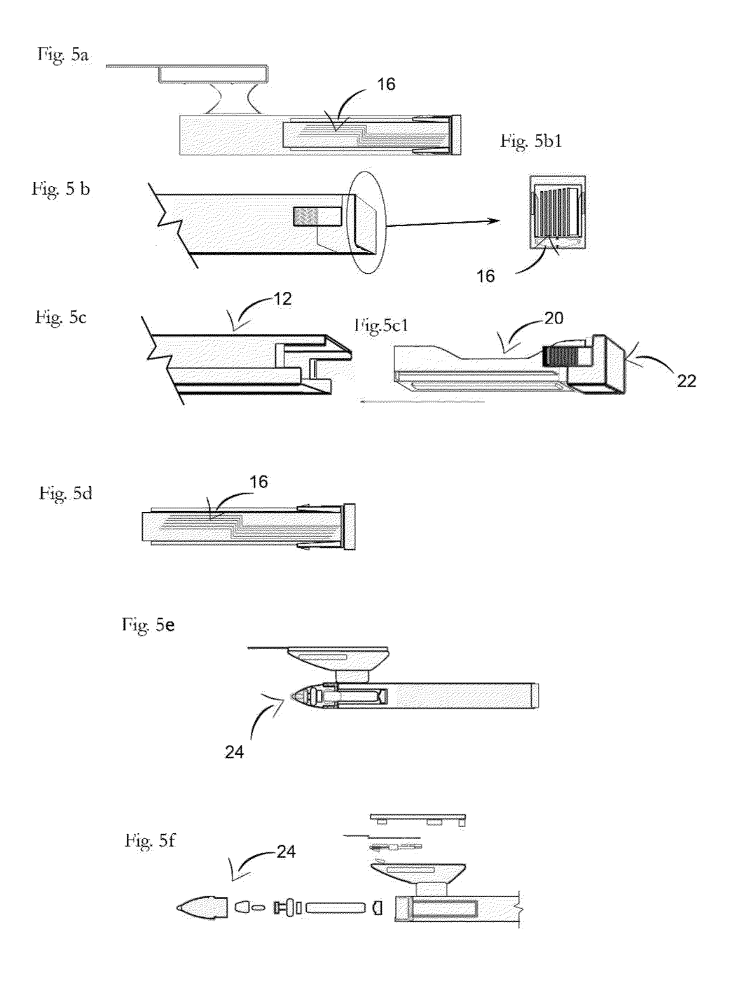

With regard to FIGS. 4a-4d, in some embodiments, the blade container 14 pivots, rotating around axis 26 as shown in FIG. 7a. In some embodiments, axis 26 is perpendicular to the longitudinal axis 28 of the handle 12. Returning to FIGS. 4a and 4c, in some embodiments, as the blade container 14 is rotated about axis 26, the blade 16 remains in a constant blade plane 30.

FIGS. 4c, 4d, and 4e illustrate that a blade 16 may be attached to the blade container 14 by means of one or more flathead screws, or other suitable flathead fasteners, seated in a beveled hole such that the flathead 50 is either flush with the blade 16 surface or recessed below the blade 16 surface, to maintain a flat blade 16 surface which contacts the adjacent surface 3.

In some embodiments, the utility Tool 10 includes one or more lights 24. In some embodiments, the light(s) 24 can be LED lights, lasers, or the like. Other types of lights are also permissible. As shown in FIG. 3, the light 24 is attached to the handle 12. As further shown in FIG. 4A, in some embodiments, a light 24 is attached to the handle 12. Further, in some embodiments, the light 24 is oriented to illuminate the blade 16. In this way, the light 24 can be angled at an angle a. relative to the longitudinal axis 28 of the handle 12. In some embodiments, a. is between approximately 30° and 60°. In some embodiments, angle a is between 35° and 50°.

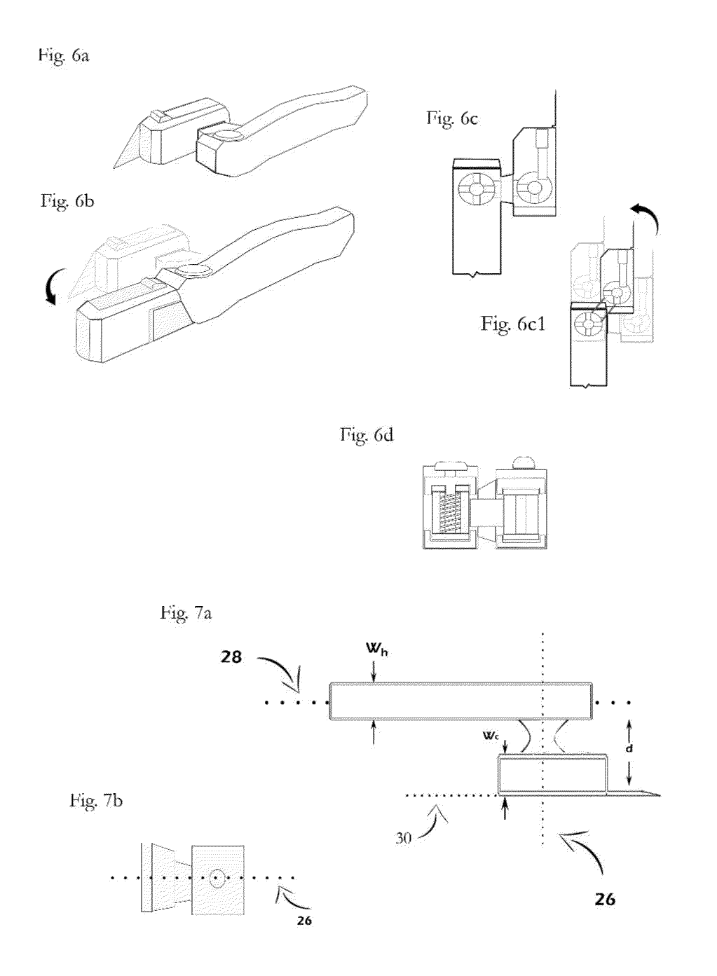

The blade container 14 can be locked, to prevent it from rotating, by way of example via a gear, or detent and spring button, catch, or other suitable mechanism. Turning to FIGS. 6a and 6b, in some embodiments, the blade container 14 may swivel such that it comes into alignment with the handle 12. This arrangement is useful, for example, when it is desirable to use the utility Tool 10 in a traditional fashion, wherein the blade 16 is aligned with the handle 12, as shown in FIG. 6b.

With regard to FIGS. 6a-6d, in some embodiments, the length, Lt, of the blade container 14 is approximately one-third the length, h, of the handle 12. As shown in FIGS. 7a-7d, the blade 16 defines a blade plane 30. In some embodiments, the blade plane 30 is offset from the longitudinal axis 28 of the handle 12. Further, the longitudinal axis 28 of the handle 12 and blade plane 30 are non-intersecting. In some embodiments, the blade plane 30 can be angled to intersect the longitudinal axis 28.

In some embodiments, the blade container 14 is attached to the handle 12 via protrusion 32, which extends therebetween. In some embodiments, the protrusion 32 rigidly connects the blade container 14 and handle 12 such that the blade container 14 is immovable with respect to the handle 12. As discussed previously, however, the blade container 14 can also be movable or selectively movable with respect to the handle 12.

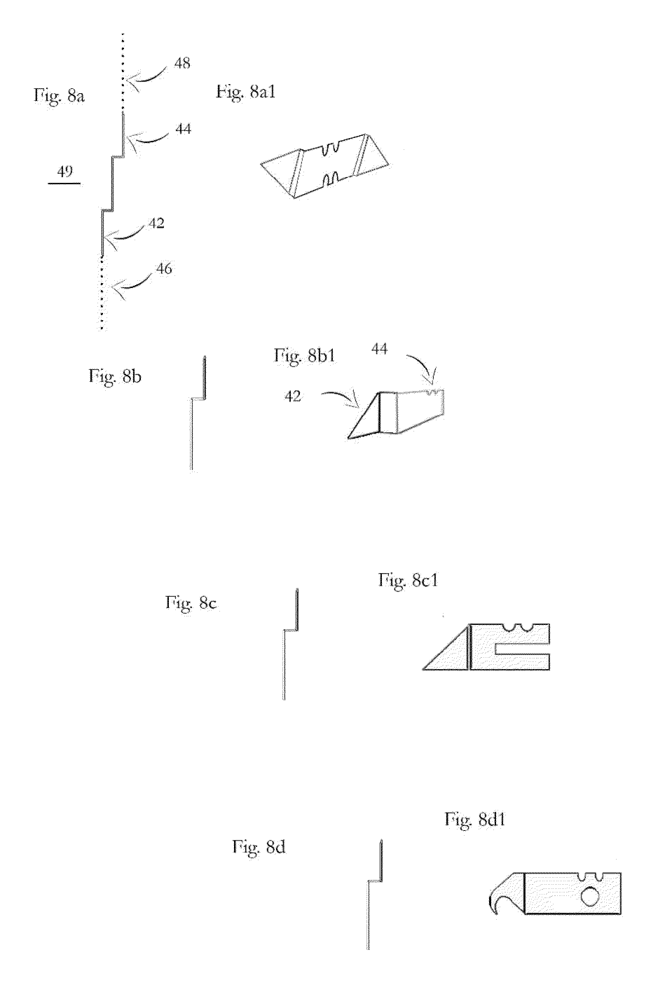

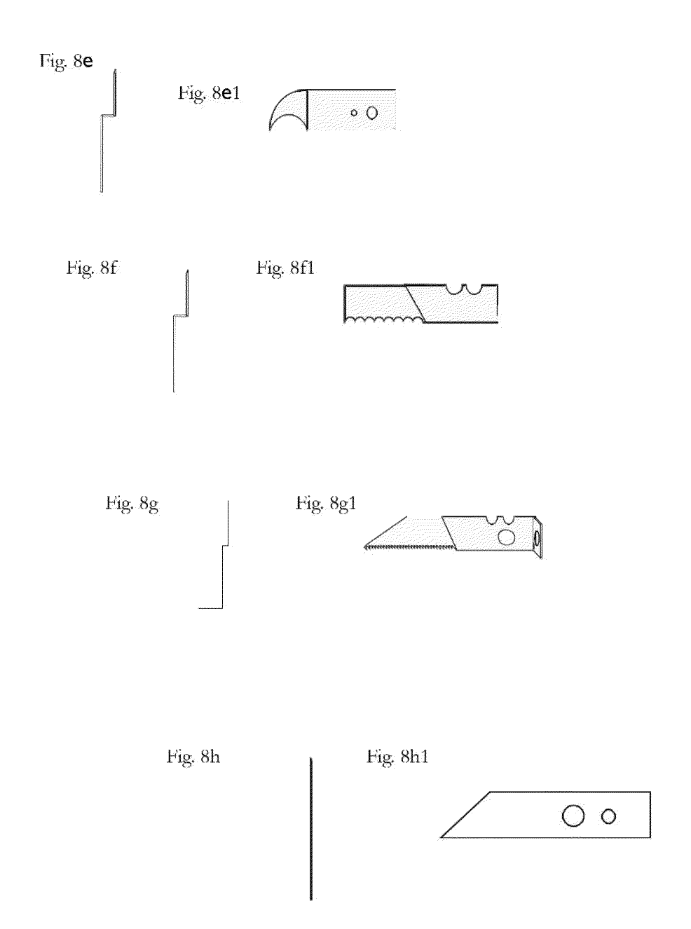

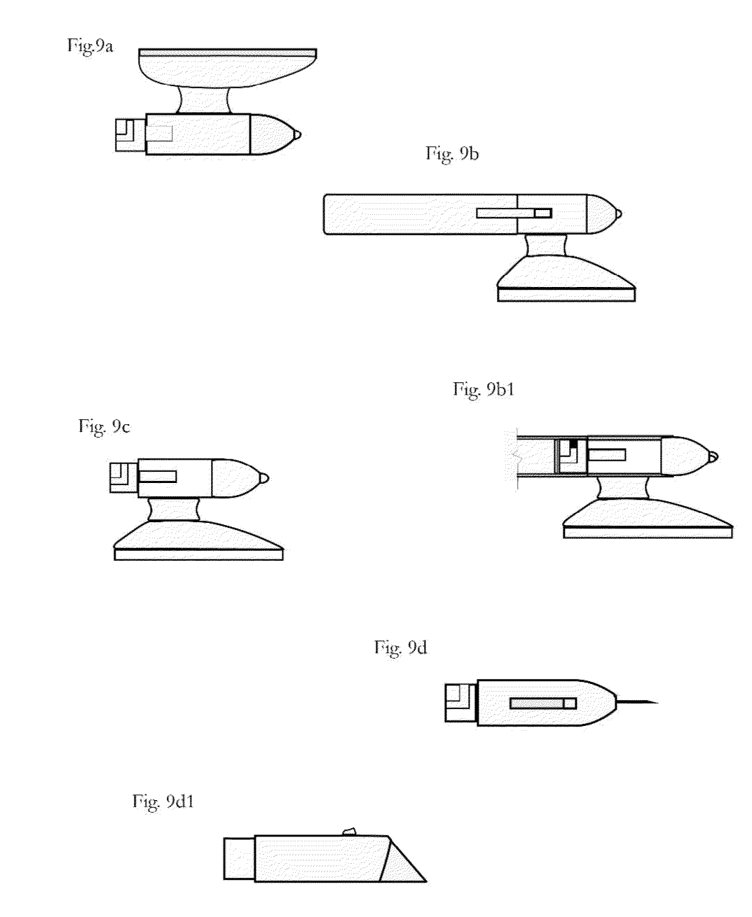

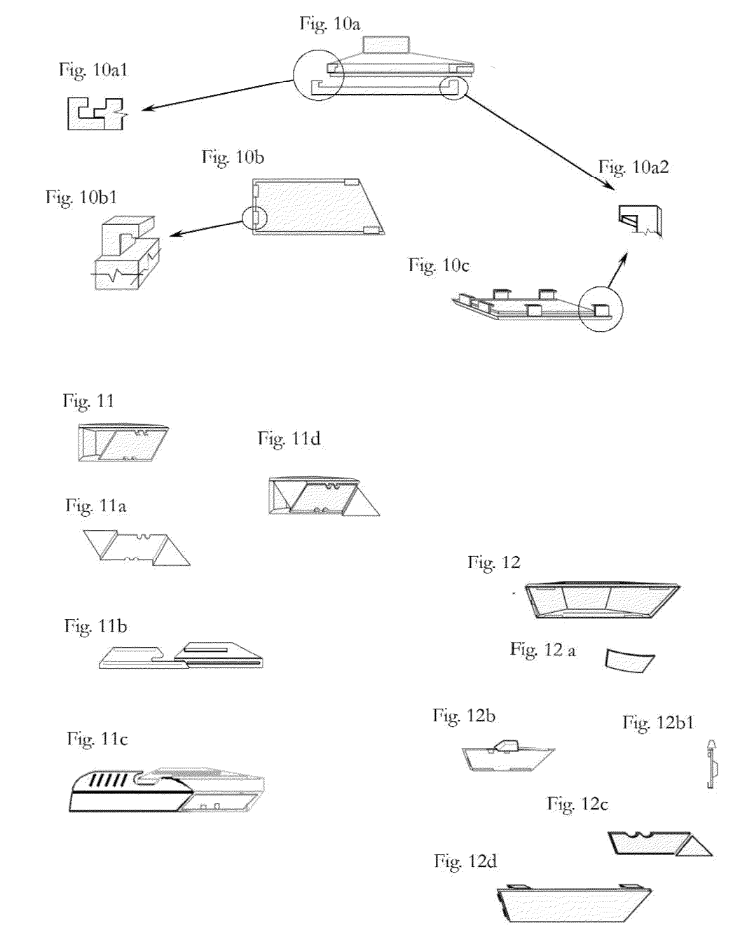

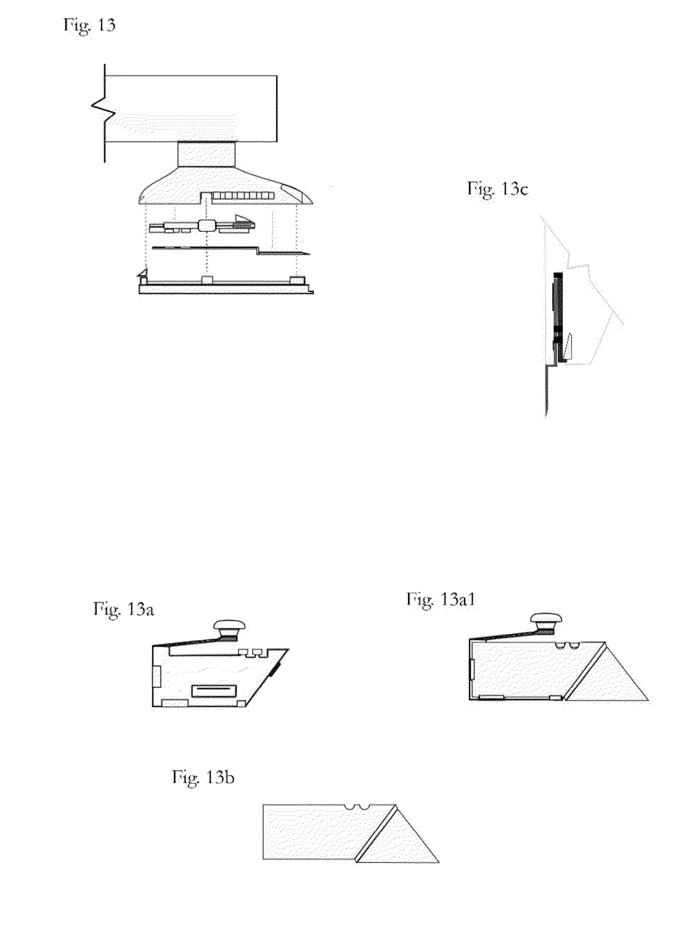

Shown in FIGS. 8a-8h are embodiments of blades 16 that can be used with the utility Tool 10. The examples of blades 16 shown in FIGS. 8a-8h have two blade portions: a first blade portion 42 and a second blade portion 44. The first blade portion 42 defines a first plane 46 and the second blade portion 44 defines a second plane 48. In some embodiments, the first plane is laterally from the second plane. In some embodiments, the first and second planes 46, 48 are parallel to one another.

With further regard to FIGS. 8a-8h, the skilled artisan will appreciate that the offset shown in these figures may be exaggerated for the purposes of illustration, and the figures, generally, are not necessarily to scale.

Either offset or non-offset blades can be used with various embodiments of the utility Tool 10. Further, in some embodiments, reversible, or double-ended, blades can be used. Non-reversible blades can also be used, in some embodiments.

In some cases a blade with two offsets is employed. FIGS. 8a and 8a1 show such a blade with two cutting surfaces facing in opposite directions thus creating a reversible blade.

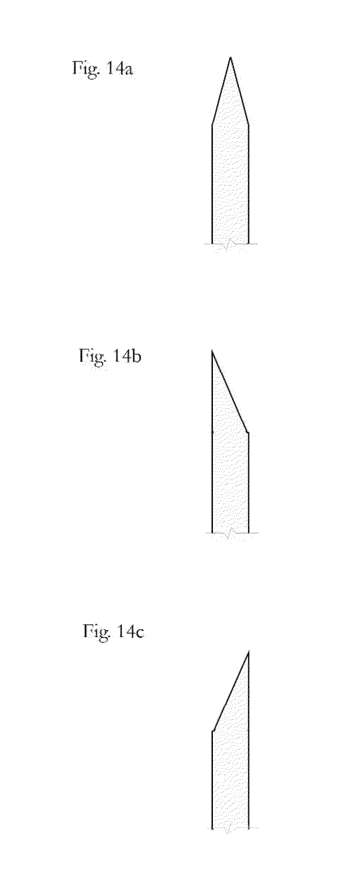

The shape of the cutting edge of a blade is also a consideration in making a cut as coplanar with the adjacent edge as possible. While cutting edge of the blade of FIG. 14a is satisfactory for most purposes, it will be recognized that cutting edge of the blade illustrated in FIG. 14b will provide superior results in this regard. FIG. 14c illustrates a left-handed version of the Blade of FIG. 14b.

FIGS. 8a through 8d1 show examples of the many blades which can be created using the offset and double offset of the present invention for specialized purposes. It will be appreciated that these blades are only a small sample of the wide variety of such blades which are contemplated within the present invention.

In some embodiments, approximately 40% of the double-ended blade is exposed from the blade container 14 for cutting.

### Sequence Listing

Not Applicable

What is claimed is:

1. A Utility Tool comprising:
a. a handle having a longitudinal axis; and
b. a blade container comprising a blade, the blade defining a blade plane, wherein the blade plane is offset from the longitudinal axis of the handle and the longitudinal axis and blade plane are non-intersecting.

2. The Utility Tool of claim 1, wherein the blade container pivots relative to the handle such that the cutting blade remains on a constant blade cutting plane.

3. The Utility Tool of claim 2, wherein a pair of washers, having a set of interlocking grooves, secure the blade in a fixed degree of rotation relative to the handle.

4. The Utility Tool of claim 1 further comprising a light, the light attached to at least one of the handle and blade container.

5. The Utility Tool of claim 1 wherein the blade includes at least one at least partially tapered hole shaped for a flat head screw and the knife further comprises at least one of said flat head screws, said one or more flat head screws attaching said blade to said blade holder.

6. A utility blade comprising a first side, a second side, and an edge side, said edge side and said second side intersecting to form a cutting edge.

7. A utility blade comprising:
a. a first blade portion; and
b. a second blade portion, the first blade portion defining a first plane and the second blade portion defining a second plane, wherein the first plane is laterally offset from the second plane.

8. The utility blade of claim 7 further comprising a center portion defining a third plane laterally offset from said first plane and said second plane and located between said first plane and said second plane.

9. The utility blade of claim 7 wherein said first blade portion forms a first cutting edge along a first edge of said utility blade and said second blade portion forms a cutting point along an opposite edge of said utility blade.
